(19) United States
(12) Patent Application Publication
(10) Pub. No.: US 2011/0026491 A1
(43) Pub. Date: Feb. 3, 2011

(54) ALLOCATION METHOD AND BASE STATION APPARATUS USING THE SAME

(75) Inventor: Makoto Nagai, Gifu (JP)

Correspondence Address: Studebaker & Brackett PC, One Fountain Square, 11911 Freedom Drive, Suite 750, Reston, VA, 20190, US

(73) Assignee: KYOCERA CORPORATION, Kyoto (JP)

(21) Appl. No.: 12/934,556

(22) PCT Filed: Mar. 27, 2009
(86) PCT No.: PCT/JP2009/056395

§ 371 Date: Sep. 24, 2010

(30) Foreign Application Priority Data
Mar. 27, 2008 (JP) 2008-084955

(51) Int. Cl. H04W 36/00

(52) U.S. Cl. 370/331

(57) ABSTRACT

A base station apparatus and an allocation method are provided. The base station apparatus includes an allocation unit and a communication unit. The allocation unit allocates, in a frame, different channels for data between a base station apparatus and a terminal device and control information about the data, the frame formed with a plurality of time slots being time-multiplexed, each time slot formed with a plurality of channels being frequency-multiplexed. The communication unit performs communication with the terminal device by using the control information and the data, to which a channel is allocated. The allocation unit, while securing at least the control information, releases at least one data which is not secured, and instructs the terminal device to perform handover process by using a time slot, in which no data is allocated.

### TECHNICAL FIELD

The present invention relates to an allocation technique, in particular, an allocation method for performing communication with a terminal device using a channel allocated to the terminal device, and a base station apparatus using the method.

### BACKGROUND ART

In a wireless communication system, there is a case where a base station apparatus connects a plurality of terminal devices. One of schemes used when a base station apparatus performs communication with a plurality of terminal devices is TDMA (Time Division Multiple Access)/TDD (Time Division Duplex). In TDMA/TDD, a frame is formed with a plurality of time slots, and furthermore, a plurality of frames are continuously arranged. A part of a plurality of time slots included in one frame is used for uplink, and the remaining is used for downlink. In such TDMA/TDD, for example, the number of time slots used for uplink and the number of time slots used for downlink in one frame are set to correspond with traffic (refer to, JP-A-Hei. 8-186533).

### DISCLOSURE OF THE INVENTION

### Problems to be Solved by the Invention

Generally, in wireless communication, effective use of limited frequency resources has been demanded. This demand is increasing with the increasing speed of communication. One of techniques to meet the demand is OFDMA (Orthogonal Frequency Division Multiple Access), which can be combined with TDMA/TDD described above. OFDMA is a technique, which frequency-multiplexes a plurality of terminal devices while using OFDM. Thus, in a combination of OFDMA and TDMA (hereinafter referred to simply as “OFDMA” without distinction from general OFDMA), a plurality of sub-channels defined in a frequency axis direction and a plurality of time slots defined in a time axis direction exist. For communication, a combination of a sub-channel and time slot (hereinafter referred to as “burst”) is used.

In this OFDMA, a base station apparatus periodically allocates a burst for data communication to each terminal device. This burst allocation is known as a “circuit switching scheme,” which is useful for communication requiring minimum transmission delay such as voice call. Meanwhile, there is communication, such as data communication, in which traffic significantly fluctuates, while minimum transmission delay is not required. For the latter communication, rather than the circuit switching scheme, a “random access scheme” is suitable, which changes the number of bursts to be allocated to a terminal device in the unit of frame according to traffic. In the random access scheme, there is a case where a plurality of bursts per frame are allocated to a terminal device. Here, in a burst, a channel which includes data (hereinafter referred to as “EDCH”) is allocated. In addition, information about EDCH is included in ECCH, which is periodically allocated.

Meanwhile, in order to improve mobility of a terminal device, handover is started when communication quality deteriorates. As a result, the terminal device moves from the base station apparatus that has performed communication (hereinafter referred to as a “handover source base station apparatus”) to a new base station apparatus (hereinafter referred to as a “handover destination base station apparatus”). In order to further improve mobility of a terminal device, it is preferable that time required for handover is shorter. In general, a terminal device searches a handover destination base station apparatus by using a time slot other than a time slot used for communication with a handover source base station apparatus. As many time slots are used for search, time for search is reduced, and time required for handover is reduced. However, in the random access scheme, since EDCH is allocated to a random burst, the number of time slots usable for search may be reduced.

The present invention has been made in view of the above circumstances, and an object is to provide communication technique which reduces time required for handover even in the case where data is allocated to a random burst.

### Means to Solve the Problem

In order to achieve the above object, an aspect of the present invention provides a base station apparatus including an allocation unit which allocates, in a frame, different channels for data between the base station and a terminal device, and control information about the data, the frame formed with a plurality of time slots by being time-multiplexed, each time slot formed with a plurality of channels by being frequency-multiplexed, and a communication unit which performs communication with the terminal device by using the control information and the data, for which channels are allocated by the allocation unit. The allocation unit, while securing at least the control information, releases at least one data which is not secured, and instructs the terminal device to perform handover process by using a time slot, in which no data is allocated.

Another aspect of the present invention provides an allocation method. The method is for allocating, in a time frame, different channels for data between a base station apparatus and a terminal device and control information about the data, the time frame formed with a plurality of time slots being time-multiplexed, each time slot formed with a plurality of channels being frequency-multiplexed, and includes while securing at least the control information, releasing at least one data which is not secured, and instructing the terminal device to perform handover process by using a time slot, in which no data is allocated.

In addition, aspects of the present invention include any combination of the elements stated above and modifications in expression, such as a method, a device, a system, a record medium, a computer program, and so on.

### Effects of the Invention

According to the present invention, time required for handover can be reduced even in the case where data is allocated to a random burst.

### BRIEF DESCRIPTION OF THE DRAWINGS

FIG. 1 is a view showing configuration of a communication system according to an embodiment of the present invention.

FIG. 2 is a view showing configuration of a TDMA frame in the communication system of FIG. 1.

FIG. 3 is a view showing configuration of an OFDMA sub-channel in the communication system of FIG. 1.

FIG. 4 is a view showing configuration of a sub-channel block in the communication system of FIG. 1.

FIG. 5 is a view showing configuration of a control channel in the communication system of FIG. 1.

FIG. 6 is a sequence view showing the sequence of TCH synchronization establishment in the communication system of FIG. 1.

FIG. 7 is a view showing configuration of a base station of FIG. 1.

FIGS. 8(a) and 8(b) are views showing allocation in a first base station apparatus of FIG. 1.

FIGS. 9(a) and 9(b) are views showing allocation in a second base station apparatus of FIG. 1.

FIG. 10 is a sequence view showing the sequence of handover process in the communication system of FIG. 1.

FIG. 11 is a flow chart showing the sequence of handover process in the first base station apparatus of FIG. 1.

FIG. 12 is a flow chart showing the sequence of handover process in a first terminal device of FIG. 1.

FIG. 13 is a flow chart showing the sequence of handover process in a second base station apparatus of FIG. 1.

FIG. 14 is a view showing data structure of a table stored in a detection unit according to a modified embodiment of the present invention.

FIGS. 15(a) and 15(b) are views showing allocation in a first base station apparatus according to a modified embodiment of the present invention.

### DESCRIPTION OF REFERENCE NUMERALS

10: base station apparatus, 12: terminal device, 20: RF unit, 22: modulation and demodulation unit, 24: baseband processing unit, 26: IF unit, 30: control unit, 40: allocation unit, 42: detection unit, 44: generation unit, 50: network, 52: control station, 100: communication system

### BEST MODE FOR CARRYING OUT THE INVENTION

The concept of the present invention is described below prior to detailed description thereof. An embodiment of the present invention relates to a communication system including a base station apparatus and at least one terminal device. In the communication system, each frame is formed with a plurality of time slots being time-division multiplexed. And, each time slot is formed with a plurality of sub-channels being frequency-division multiplexed. In addition, each sub-channel is formed with multi-carrier signals. OFDM signals are used for the multi-carrier signals, and OFDMA is used for the frequency-division multiplexing. The base station apparatus performs communication with a plurality of terminal devices by allocating each of a plurality of sub-channels included in each time slot to the terminal devices.

There exist a plurality of types of data, which are objects for communication with a plurality of terminal devices. According to types of data, a different communication speed or different delay time is required. For example, voice communication generally requires shorter delay time than that for data communication. For data communication, the communication speed varies depending on data contents. Thus, if short delay time is required, it is desirable to periodically allocate a burst similarly to the circuit switching scheme. For example, a base station apparatus periodically allocates a burst in a frame period. Meanwhile, if the circuit switching scheme is applied to a terminal device not requiring short delay time, it will cause unnecessary allocation and make it difficult to respond to variation of data amount.

Thus, data communication employs the random access scheme, which allows a base station apparatus to randomly allocate a burst to each terminal device. Hereinafter, in the random access scheme, a channel of data to be allocated to a burst will be referred to as “EDCH.” Further, in the random access scheme, control information (hereinafter referred to as “ECCH”) about EDCH is generated in the unit of frame. ECCH includes information about a burst, in which EDCH is allocated, a communication speed of EDCH, and the like. A base station apparatus periodically performs communication with each terminal device using ECCH. A terminal device receives ECCH and confirms the content of the ECCH to recognize a burst to which EDCH is allocated.

If quality of communication between a terminal device and a handover source base station apparatus deteriorates, the terminal device searches a handover destination base station apparatus by using a time slot other than a time slot that have already been used for the communication. In other words, the terminal device receives notification signals notified from base station apparatuses to recognize the existence of the base station apparatuses and selects a handover destination base station apparatus from the recognized base station apparatuses. If communication between the terminal device and the handover source base station apparatus is performed using the random access scheme, a plurality of EDCHs might have been allocated. In this case, the number of time slots, in which no EDCH is allocated, may be reduced. As a result, time required to search a handover destination base station apparatus is prolonged, so that time required for handover is also prolonged.

In order to solve this problem, the base station apparatus according to an embodiment of the present invention, in particular, the handover source base station apparatus, specifies a time slot, in which ECCH is allocated, and releases EDCH allocated in a time slot other than the specified time slot. In other words, only EDCH allocated in the specified time slot is maintained between the handover source base station apparatus and the terminal device. The terminal device releases EDCH in accordance with determination in the handover source base station apparatus. As a result, the number of time slots that can be used to receive notification signals increases. Accordingly, time required to search a handover destination base station apparatus is reduced, and time required for handover is also reduced.

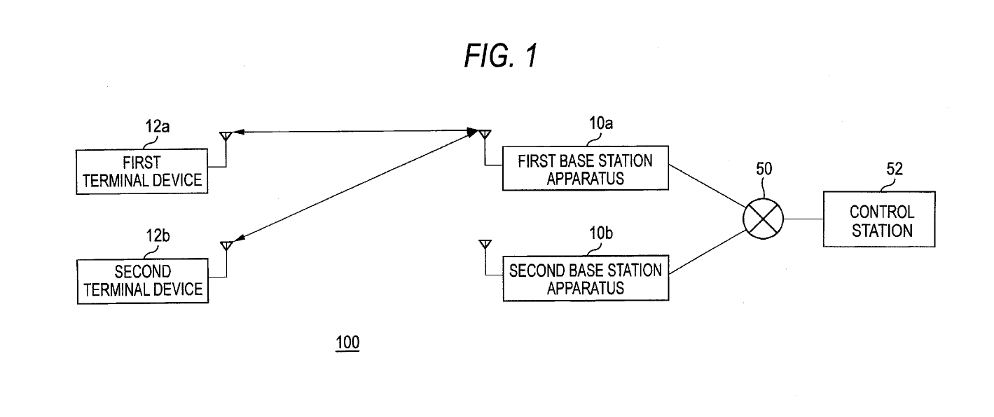

FIG. 1 shows configuration of a communication system 100 according to an embodiment of the present invention. The communication system 100 includes a first base station apparatus 10a and a second base station apparatus 10b, which are collectively referred to as a base station apparatus 10, a first terminal device 12a and a second terminal device 12b, which are collectively referred to as a terminal device 12, a network 50, and a control station 52.

One end of the base station apparatus 10 is connected to the terminal device 12 through a wireless network, and the other end thereof is connected to the network 50 as a wired network. Further, the base station apparatus 10 is connected to the control station 52 through the network 50. The terminal device 12 is connected to the base station apparatus 10 through a wireless network. Since the base station apparatus 10 has a plurality of time slots and a plurality of sub-channels, it performs TDMA by means of the plurality of time slots and OFDMA by means of the plurality of sub-channels. As described above, a combined unit of time slot and sub-channel is defined as a burst. The base station apparatus 10 allocates a burst to each of the plurality of terminal devices 12 to perform communication with the plurality of terminal devices 12. The base station apparatus 10 defines one of a plurality of sub-channels as a control channel. In the control channel, the base station apparatus 10 periodically transmits a notification signal such as BCCH.

The terminal device 12 receives BCCH to recognize the existence of the base station apparatus 10 and make a ranging request to the base station apparatus 10. The base station apparatus 10 responds to the ranging request. Ranging is a process to correct a frequency offset and a timing offset in the terminal device 12. Since known technique for ranging can be used, explanation thereof is omitted herein. Thereafter, the terminal device 12 transmits a burst allocation request signal to the base station apparatus 10. In response to the received request signal, the base station apparatus 10 allocates a burst to the terminal device 12. Here, the communication system 100 employs two allocation schemes, i.e., the circuit switching scheme and the random access scheme.

The base station apparatus 10 transmits information about the allocated burst to the terminal device 12, and the terminal device 12 perform communication with the base station apparatus 10 by using the allocated burst. As a result, data transmitted from the terminal device 12 is output to a wired network through the base station apparatus 10 and is finally received in a communication device not illustrated herein and connected by the wired network. The data is also transmitted in the direction from the communication device to the terminal device 12. Here, the base station apparatus 10 allocates ECCH in the unit of frame to the terminal device 12 that is employing the random access scheme. The base station apparatus 10 allocates EDCH to the corresponding terminal device 12. The number of EDCH in a frame varies depending on the unit of frame. Here, control information about EDCH is included in ECCH. For example, a burst in a frame to which EDCH is allocated, and communication speed of EDCH, etc., are included in ECCH. The details will be described later.

For example, the first base station apparatus 10a corresponds to a handover source base station apparatus, and a second base station apparatus 10b corresponds to a handover destination base station apparatus. During communication between the terminal device 12 and the first base station apparatus 10a, start of handover is notified from any of them. The terminal device 12 specifies the second base station apparatus 10b as a handover destination base station apparatus by monitoring a control channel. The process in this case will be described later. The communication between the terminal device 12 and the first base station apparatus 10a is disconnected, and the terminal device 12 requests connection to the second base station apparatus 10b. Thereafter, communication between the terminal device 12 and the second base station apparatus 10b is started.

The control station 52 is connected to the base station apparatus 10 through the network 50. The control station 52 performs location registration for the terminal device 12 through the base station apparatus 10. Location registration means management of which paging area the terminal device 12 belongs to. Since known technique for location registration can be used, explanation thereof is omitted herein. The control station 52 receives incoming call notification to the terminal device 12 from a switching device, and etc., not illustrated herein. The control station 52 specifies to which paging area the terminal device 12 responding to the incoming call notification belongs, based on the result of the location registration. Furthermore, the control station 52 transmits the incoming call notification to the base station apparatus 10, which belongs to the paging area. The network 50 is connected to the control station 52 and also is connected to the base station apparatus 10. For example, the network 50 is configured by an IP (Internet Protocol) network, but is not limited thereto.

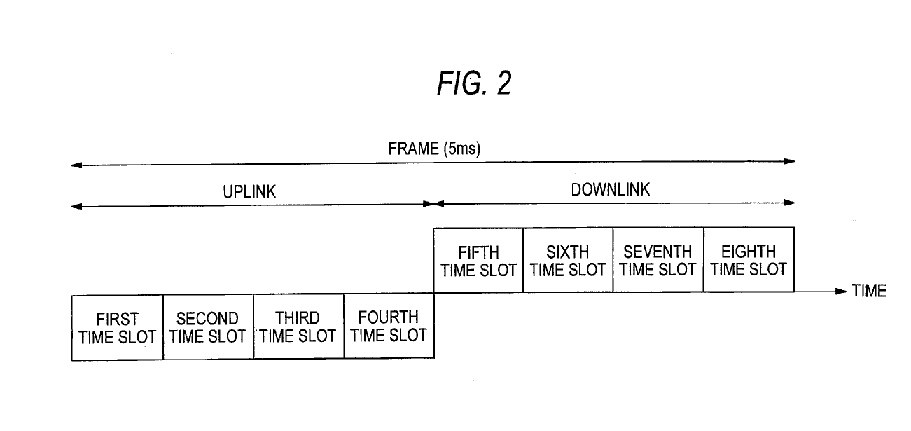

FIG. 2 shows configuration of a TDMA frame in the communication system 100. In the communication system 100, a frame is formed with four time slots for uplink communication and four time slots for downlink communication, like a second-generation codeless telephone system. Here, the four time slots for uplink communication correspond to uplink sub-frames. The four time slots for downlink communication correspond to downlink sub-frames. The frames are continuously arranged. In an embodiment of the present invention, allocation of time slots for uplink communication is the same as allocation of time slots for downlink communication. Thus, for convenience, hereinafter, only downlink communication may be described.

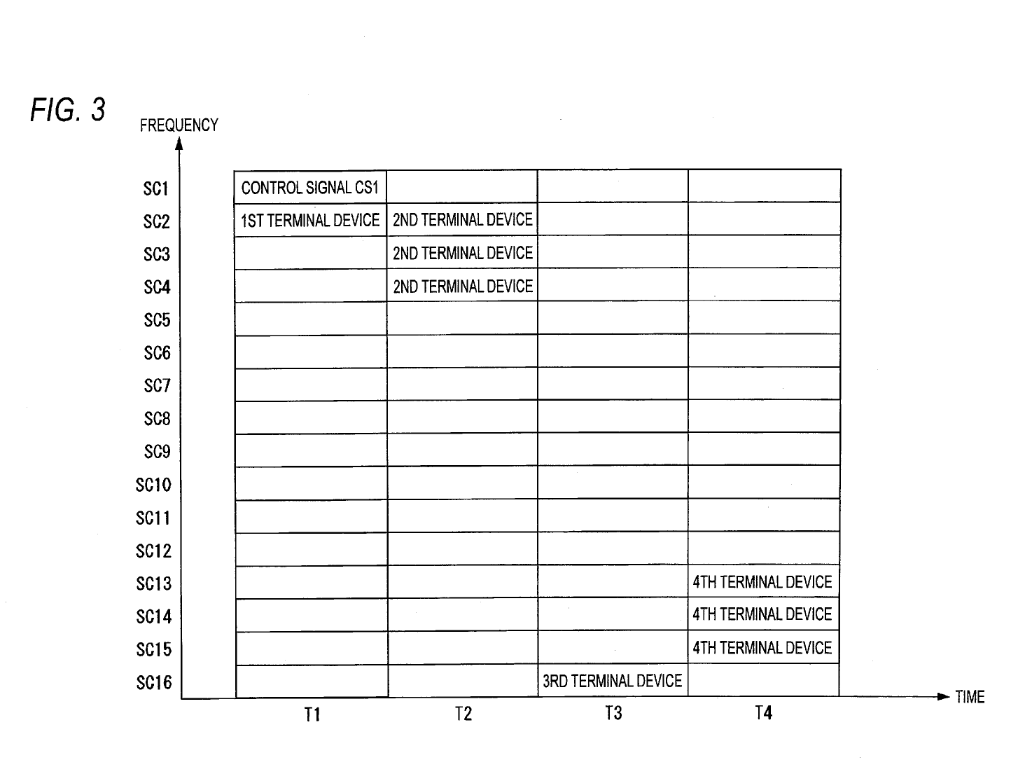

FIG. 3 shows configuration of OFDMA sub-channels in the communication system 100. The base station apparatus 10 employs OFDMA as illustrated in FIG. 3, in addition to the TDMA that has been described. As a result, a plurality of terminal devices are allocated to one time slot. In FIG. 3, the horizontal axis direction relates to arrangement of time slots on a time axis, and the vertical axis direction relates to arrangement of sub-channels on a frequency axis. In other words, the multiplexing of the horizontal axis corresponds to TDMA, and the multiplexing of the vertical axis corresponds to OFDMA. Here, one frame includes a first time slot (“T1” in FIG. 3) to a fourth time slot (“T4” in FIG. 3). For example, T1 to T4 in FIG. 3 correspond to the fifth time slot to the eighth time slot in FIG. 2, respectively.

Each time slot includes a first sub-channel (“SC1” in the drawing) to a sixteenth sub-channel (“SC16” in the drawing). In FIG. 3, the first sub-channel is secured as a control channel. In the drawing, the first base station apparatus 10a (“CS1” in the drawing) allocates a control signal to the first sub-channel of the first time slot. That is, the frame configuration only in terms of SC1 and a set of a plurality of frames correspond to LCCH. In FIG. 3, the first terminal device 12a is allocated to the second sub-channel of the first time slot. The second terminal device 12b is allocated to the second sub-channel to the fourth sub-channel of the second time slot. In addition, the third terminal device 12c is allocated to the sixteenth sub-channel of the third time slot, and the fourth terminal device 12d is allocated to the thirteenth sub-channel to the fifteenth sub-channel of the fourth time slot. Among them, a burst allocated to the first terminal device 12a and a burst allocated to the third terminal device 12c correspond to ECCH.

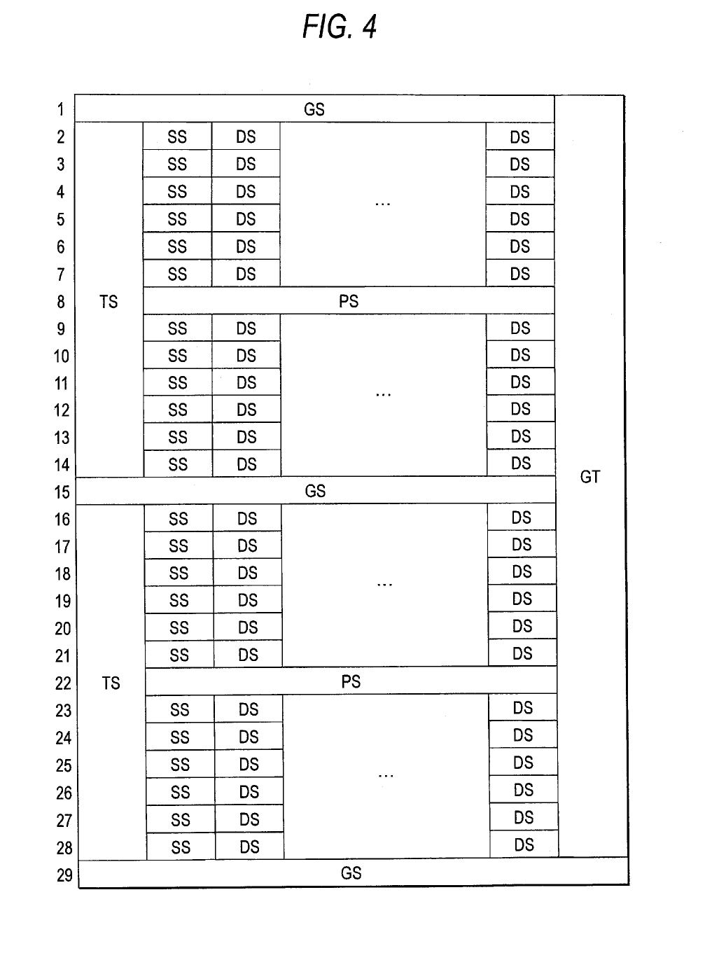

FIG. 4 shows configuration of a sub-channel block in the communication system 100. A sub-channel block is a wireless channel specified by a time slot and a sub-channel. In FIG. 4, the horizontal direction relates to a time axis, and the vertical direction relates to a frequency axis. The numerals, “1” to “29,” refer to numbers of sub-carriers. That is, a sub-channel is configured by OFDM multi-carrier signals. In the drawing, “TS” is a training symbol, which includes known signals, such as “STS,” a symbol for synchronization detection, and “LTS,” a symbol for estimation of a characteristic of a transmission channel, which are not illustrated. “GS” is a guard symbol, in which no effective signal is provided. “PS” is a pilot symbol, which is configured by a known signal. “SS” is a signal symbol, in which a control signal is provided. “DS” is a data symbol, namely, refers to data to be transmitted. “GT” is a guard time, in which no effective signal is provided.

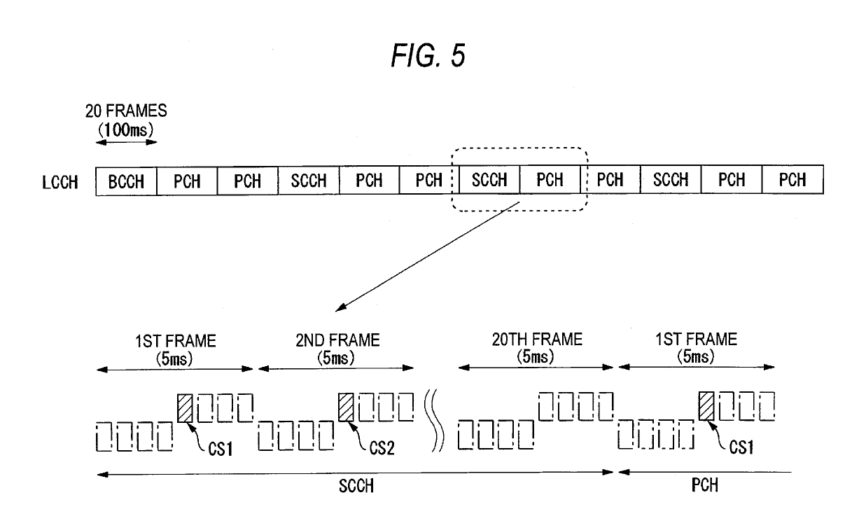

FIG. 5 shows configuration of a control channel in the communication system 100. The control channel is configured by BCCH, PCH, PCH, SCCH, PCH, PCH, SCCH, PCH, PCH, SCCH, PCH, and PCH. Each of BCCH, SCCH, and PCH is configured by 20 TDMA frames (hereinafter referred to as “frame”). In addition, one frame is configured as illustrated in FIG. 2. In FIG. 5, for explanation convenience, a frame, in which PCH, BCCH, and SCCH are allocated, is also illustrated as “PCH,” “BCCH,” and “SCCH.” In addition, although a frame is divided into a plurality of time slots as described above, the terms, “PCH,” “BCCH,” and “SCCH,” are used, irrespective of each of the time slot unit, the frame unit, and the 20-frame unit.

In the drawing, “SCCH” is a channel for each cell. In addition, “TCCH” is allocated in an uplink time slot corresponding to SCCH. “TCCH” corresponds to an initial ranging request, which is transmitted from the terminal device 12 to the base station apparatus 10. The base station apparatus receives TCCH from the terminal device and performs ranging process. Since known technique for ranging process can be used, explanation thereof is omitted herein.

The lower portion of FIG. 5 shows configuration of each frame, which is the same as illustrated in FIG. 2. In addition, this configuration corresponds to the frame configuration for SC1 of FIG. 4. The first base station apparatus 10a of FIG. 1 occasionally transmits BCCH, SCCH, and PCH at 20-frame intervals in a time slot (“CS1” in the drawing), to which LCCH is allocated, among time slots configuring a frame. In other words, the first base station apparatus 10a uses a fifth time slot of a first frame among 20 frames configuring SCCH and a fifth time slot of a first frame among 20 frames configuring PCH.

The second base station apparatus 10b illustrated in FIG. 1 occasionally transmits BCCH, SCCH, and PCH at 20-frame intervals in a time slot (“C52” in the drawing), which has the same position from the frame head as the time slot being used by the first base station apparatus 10a, among time slots of a frame (a second frame in the drawing) next to the frame that the first base station apparatus 10a has transmitted. As a result of this configuration, each of 4 downlink time slots configuring a frame can multiplex 20 base station apparatuses such that maximum 80 base station apparatuses can be multiplexed.

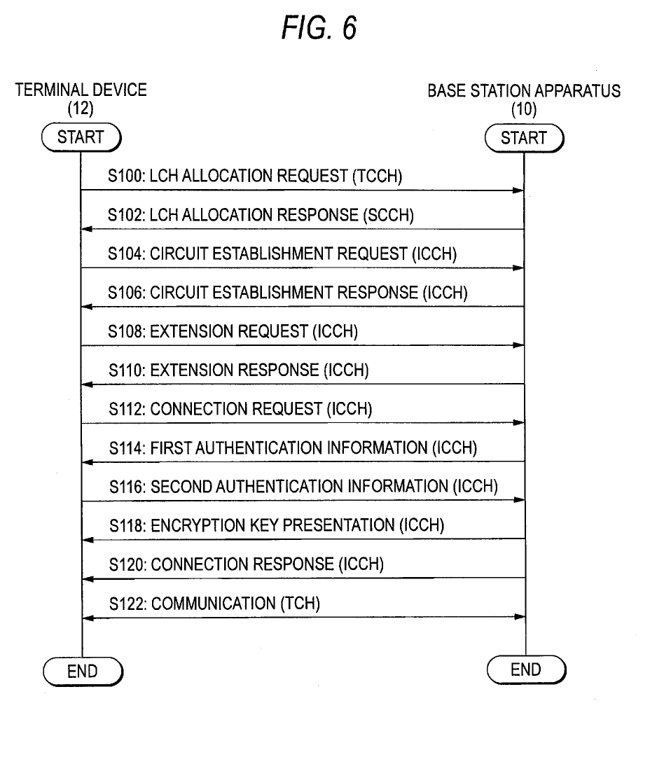

FIG. 6 is a sequence view showing the sequence of TCH synchronization establishment in the communication system 100. This sequence view is related to the case where the circuit switching scheme described above is performed. In addition, herein, the name of a channel will be in a parenthesis in correspondence to the name of a signal. The terminal device 12 transmits a LCH allocation request (TCCH) to the base station apparatus 10 (S100). The base station apparatus 10 transmits a LCH allocation response (SCCH) to the terminal device 12 (S102). The terminal device 12 transmits a circuit establishment request (ICCH) to the base station apparatus 10 (S104). It is noted that ICCH is a control channel, which is allocated to a sub-channel separated from LCCH. The base station apparatus 10 transmits a circuit establishment response (ICCH) to the terminal device 12 (S106).

The terminal device 12 transmits an extension request (ICCH) to the base station apparatus 10 (S108). The base station apparatus 10 transmits an extension response (ICCH) to the terminal device 12 (S110). The terminal device 12 transmits a connection request (ICCH) to the base station apparatus 10 (S112). The base station apparatus 10 transmits first authentication information (ICCH) to the terminal device 12 (S114). The terminal device 12 transmits second authentication information (ICCH) to the base station apparatus 10 (S116). The base station apparatus 10 transmits encryption key presentation (ICCH) to the terminal device 12 (S118). The base station apparatus 10 transmits a connection response (ICCH) to the terminal device 12 (S120). The terminal device 12 and the base station apparatus 10 perform communication (TCH) (S122).

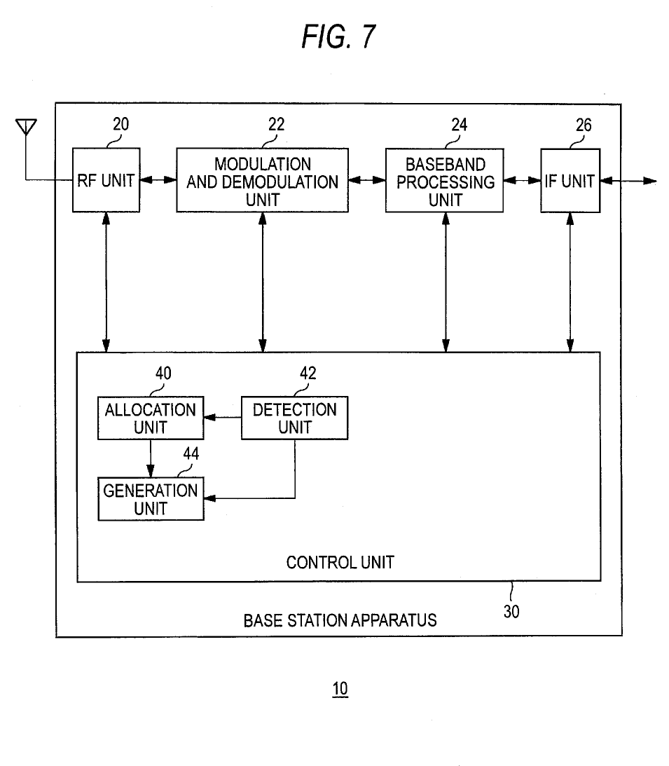

FIG. 7 shows configuration of the base station apparatus 10. The base station apparatus 10 includes a RF unit 20, a modulation and demodulation unit 22, a baseband processing unit 24, an IF unit 26, and a control unit 30. In addition, the control unit 30 includes an allocation unit 40, a detection unit 42, and a generation unit 44. It is noted that the first base station apparatus 10a is the same type as the second base station apparatus 10b.

With respect to receiving process, the RF unit 20 performs frequency conversion for wireless frequency multi-carrier signals received from the terminal device 12, not illustrated herein, and generates baseband multi-carrier signals. Here, the multi-carrier signals are formed as illustrated in FIG. 3 and correspond to the uplink time slots of FIG. 2. Furthermore, the RF unit 20 outputs the baseband multi-carrier signals to the modulation and demodulation unit 22. Generally, since a baseband multi-carrier signal is formed with an in-phase component and a quadrature-phase component, it should be transmitted through two signal lines. However, herein, for clarity in drawings, only one signal line is illustrated. The RF unit 20 also includes an AGC or an A/D conversion unit.

With respect to transmitting process, the RF unit 20 performs frequency conversion for the baseband multi-carrier signals input from the modulation and demodulation unit 22 and generates wireless frequency multi-carrier signals. Furthermore, the RF unit 20 transmits the wireless frequency multi-carrier signals. Than, the RF unit 20 transmits the multi-carrier signals by using the same wireless frequency band as that for the received multi-carrier signals. That is, TDD is used as illustrated in FIG. 2. The RF unit 20 also includes a PA (Power Amplifier) and a D/A conversion unit.

With respect to receiving process, the modulation and demodulation unit 22 performs FFT for the baseband multi-carrier signals input from the RF unit 20 to convert from the time domain into the frequency domain. The multi-carrier signals that have converted into the frequency domain have components corresponding to the plurality of respective sub-carriers as illustrated in FIG. 3 or FIG. 4. The modulation and demodulation unit 22 also performs timing synchronization, i.e., setting FFT window, and deletion of guard intervals. Since known technique for timing synchronization, and etc., can be used, explanation thereof is omitted herein. The modulation and demodulation unit 22 demodulates the multi-carrier signals that have converted into the frequency domain. For the demodulation, a transmission channel characteristic is estimated. Estimation of a transmission channel characteristic is performed in the unit of sub-carriers. The modulation and demodulation unit 22 outputs the demodulation result to the baseband processing unit 24.

With respect to transmitting process, the modulation and demodulation unit 22 performs modulation for the multi-carrier signals received from the baseband processing unit 24. The modulation and demodulation unit 22 performs IFFT for the modulated multi-carrier signals to convert from the frequency domain into the time domain. The modulation and demodulation unit 22 outputs the multi-carrier signals that have converted into the time domain to the RF unit 20 as baseband multi-carrier signals. The modulation and demodulation unit 22 also performs addition of guard intervals, which is not explained herein.

With respect to receiving process, the baseband processing unit 24 receives the demodulation result from the modulation and demodulation unit 22 and divides the demodulation result into the unit of the terminal device 12. In other words, the demodulation result is configured by a plurality of sub-channels as illustrated in FIG. 3. Therefore, in case where one sub-channel is allocated to one terminal device 12, the demodulation result includes signals from a plurality of the terminal devices 12. The baseband processing unit 24 divides such a demodulation result into the unit of the terminal device 12. The baseband processing unit 24 adds information for identifying the terminal devices 12 as transmission sources and information for identifying destination to the divided demodulation result and outputs it to the IF unit 26.

With respect to transmitting process, the baseband processing unit 24 receives data addressed from the IF unit 26 to the plurality of the terminal devices 12, allocates the data to sub-channels, and forms multi-carrier signals from the plurality of sub-channels. That is, the baseband processing unit 24 forms multi-carrier signals configured by a plurality of sub-channels as illustrated in FIG. 3. Sub-channels to which data should be allocated are determined as illustrated in FIG. 3. An instruction thereon is received from the control unit 30. The baseband processing unit 24 outputs the multi-carrier signals to the modulation and demodulation unit 22.

With respect to receiving process, the IF unit 26 outputs the demodulation result received from the baseband processing unit 24 to a wired network, not illustrated herein. Destination of the demodulation result is determined based on the information that has been added to the demodulation result in order to identify the destination. Here, information to identify destination is disclosed, for example, in an IP (Internet Protocol) address. In addition, with respect to transmitting process, the IF unit 26 inputs the data for the plurality of the terminal devices 12 from a wired network, not illustrated herein. The control unit 30 outputs the input data to the baseband processing unit 24.

The control unit 30 performs allocation of bursts to the terminal devices 12, timing control for the entire base station apparatus 10, and others. For the allocation of bursts, the control unit 30 performs the circuit switching scheme and the random access scheme. The control unit 30 performs, for example, the circuit switching scheme in response to a request from the terminal device 12. In other words, the control unit 30 periodically allocates a burst to the corresponding terminal device 12. For example, a burst included in a time slot of a frame period is allocated to the first terminal device 12a. It is noted that the allocation of a burst has only to be periodically performed and is not limited to a frame period, namely, may be performed in a longer or shorter period than a frame period.

The control unit 30 performs the random access scheme in response to a request from another terminal device 12. That is, the control unit 30 modifies allocation of a burst to the corresponding terminal device 12 in the unit of frame. For example, the control unit 30 determines the number of bursts to be allocated while reflecting traffic with the terminal device 12. The control unit 30 periodically allocates ECCH to the terminal device 12 and allows the ECCH to include information about the allocated burst. Here, the control unit 30 notifies the allocation of ECCH when transmitting SCCH. Accordingly, ECCH is periodically allocated, similarly to TCH in the circuit switching scheme.

The operation of the control unit 30 will be explained in more detail. Herein, in particular, (1) operation in case of new connection, (2) basic operation in the random access scheme, and (3) operation in case of handover, which are related to an embodiment of the present invention, will be described in order. For clear explanation, process in one terminal device 12 will be explained.

(1) Operation in Case of New Connection

After ranging process is finished, the allocation unit 40 receives a LCH allocation request from the terminal device 12, not illustrated herein and not connected, through the RF unit 20 to the IF unit 26. The allocation unit 40 allocates a burst to the corresponding terminal device 12 based on the LCH allocation request. In addition, information indicating whether allocation using the circuit switching scheme or allocation using the random access scheme is desired for any one signal upon synchronization establishment may be included. The allocation unit 40 determines allocation using the circuit switching scheme or the random access scheme based on the information. In addition, in either case, symmetric allocation of busts is performed for uplink sub-frames and downlink sub-frames. If the circuit switching scheme is performed, the allocation unit 40 directly allocates TCH, i.e., a burst in which data should be included, to the terminal device 12.

Meanwhile, if the random access scheme is performed, the allocation unit 40 directly allocates ECCH, i.e., a burst which includes information about EDCH, to the terminal device 12. Accordingly, allocation of a burst to EDCH is transmitted to the terminal device 12 through ECCH. In other words, the allocation unit 40 allocates a different burst to each of EDCH and ECCH, in a frame. The allocation unit 40 transmits the result of TCH allocation in the circuit switching scheme or the result of ECCH allocation in the random access scheme as wireless resource allocation SCCH from the IF unit 26 to the RF unit 20 to the terminal device 12, not illustrated herein. The non-illustrated terminal device 12 performs communication based on the content of the wireless resource allocation SCCH.

(2) Basic Operation in the Random Access Scheme

The allocation unit 40 determines a burst to be allocated to EDCH in the unit of frame. Allocation of a burst to EDCH is performed to each of uplink EDCH and downlink EDCH. The generation unit 44 stores the result of burst allocation to each of uplink EDCH and downlink EDCH in ECCH. ECCH also includes communication speed and other information about EDCH. Communication speed is determined by a modulation method and a coding rate of error corrections.

In addition, ECCH includes ACK/NACK information about past EDCH. The ACK/NACK information is used for ARQ (Automatic Repeat Request) or HARQ, which is not explained herein. This ECCH corresponds to downlink ECCH and contains uplink ECCH as well. The uplink ECCH is transmitted from the terminal device 12, not illustrated herein, and includes communication speed information of EDCH or information of ACK/NACK. After notification of ECCH, EDCH communication is performed between the base station apparatus 10 and the terminal device 12 based on the information included in the ECCH. In other words, in case of the random access scheme, the RF unit 20 and the IF unit 26 perform communication with the terminal device 12 through the ECCH and the EDCH, to which a burst is allocated in the allocation unit 40.

(3) Operation in Case of Handover

Handover is performed, irrespective of the circuit switching scheme or the random access scheme. Herein, handover in case of the random access scheme will be described. Firstly, process in a handover source base station apparatus, i.e., the first base station apparatus 10a, will be described. The detection unit 42 detects a handover start trigger during communication with the terminal device 12. The handover start trigger may be detected by using a known technique. For example, the detection unit 42 measures quality of communication with the terminal device 12 through the RF unit 20 to the IF unit 26 and determines that a handover start trigger has been detected if the communication quality becomes lower than a threshold value. Herein, for the communication quality, an error rate and receiving power, etc., are measured. In addition, the detection unit 42 may determine that a handover start trigger has been detected, if a handover request has been received from the terminal device 12 through the RF unit 20 to the IF unit 26. If a handover start trigger has been detected, the detection unit 42 notifies the detection to the allocation unit 40 and the generation unit 44.

Upon receiving from the detection unit 42 the information that a handover start trigger has been detected, the allocation unit 40 confirms a burst allocated to ECCH, and a burst allocated to EDCH. Although allocation of a burst to EDCH is different depending on the unit of frame as described above, herein, for simplification of process, difference in burst allocation between neighboring frames would be small. The allocation unit 40 specifies a time slot, in which a burst allocated to ECCH is included. The allocation unit 40 releases EDCH included in time slots other than the specified time slot while securing at least EDCH included in the specified time slot. The allocation unit 40 notifies information about EDCH to be released or information about EDCH to be secured to the generation unit 44.

The generation unit 44 receives from the detection unit 42 the information that a handover start trigger has been detected and also receives from the allocation unit 40 the information described above. The generation unit 44 includes information about the secured EDCH therein to generate downlink ECCH. In addition, the generation unit 44 generates an instruction signal indicating that handover will be started in the terminal device 12. The generation unit 44 transmits the downlink ECCH and the instruction signal to the terminal device 12 through the IF unit 26 to the RF unit 20. As a result of the foregoing process, the control unit 30 instructs the terminal device 12 to perform handover using time slots, in which no EDCH is allocated.

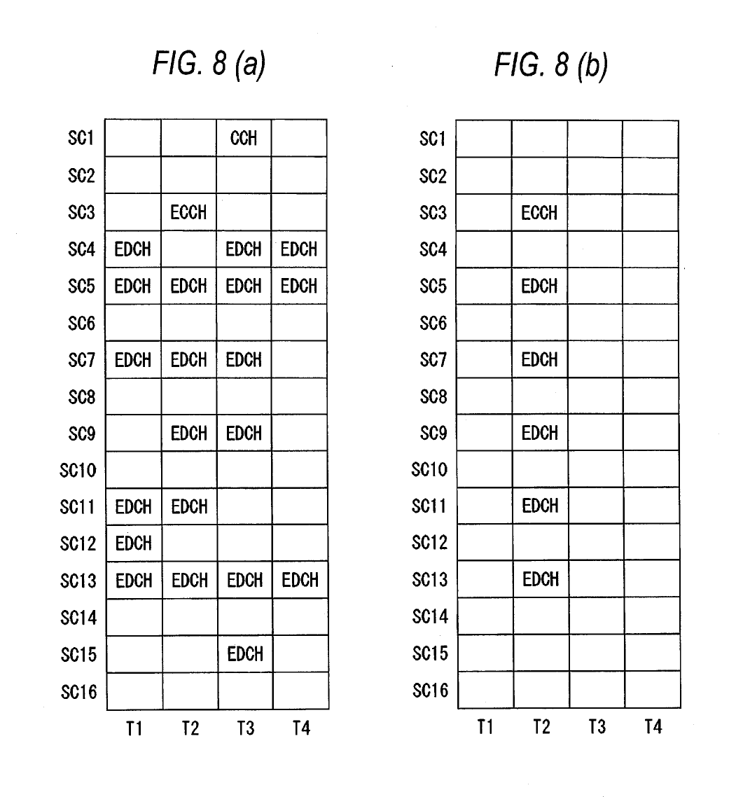

FIGS. 8(a) and 8(b) show allocation in the first base station apparatus 10a. The reference marks in FIGS. 8(a) and 8(b) are the same as those in FIG. 3. FIG. 8(a) shows allocation of a burst prior to performing handover. The first base station apparatus 10a allocates a control channel (also referred to as “CCH”) to T3 of SC1 and ECCH for the first terminal device 12a to T2 of SC3. In addition, the first base station apparatus 10a allocates EDCH for the first terminal device 12a to T1 of SC4, and etc. As illustrated, allocation of EDCH is performed from T1 to T4.

FIG. 8(b) shows allocation when handover is performed. As described above, the allocation unit 40 specifies the time slot, “T2,” in which ECCH is allocated. The allocation unit 40 secures EDCH allocated in the time slot, “T2.” Accordingly, the allocation of EDCH in T2 of FIG. 8(b) is identical to the allocation of EDCH in FIG. 8(a). Meanwhile, the allocation unit 40 releases all EDCH in the time slots, “T1,” “T3,” and “T4,” other than the specified time slot. In addition, the generation unit 44 notifies the allocation of EDCH to the terminal device 12 through ECCH. Attention is returned to FIG. 7.

Next, process in a handover destination base station apparatus, i.e., the second base station apparatus 10b, will be described. In addition, since handover process in the handover destination base station apparatus is the same as that in the operation in case of new connection described in Item (1) above, herein, differences will be described. When receiving a handover process request from the terminal device 12, the allocation unit 40 of the second base station apparatus 10b allocates ECCH for the corresponding terminal device 12 in a time slot, in which a control channel is allocated. This is intended to avoid overlapping between a time slot, to which ECCH is allocated in the handover source base station apparatus, and a time slot, to which ECCH is allocated in the handover destination base station apparatus. In addition, the allocation unit 40 allocates EDCH in a time slot, in which ECCH is allocated. The generation unit 44 allows ECCH to include the allocation described above and notifies the ECCH to the terminal device 12. In addition, after communication between the terminal device 12 and the first base station apparatus 10a is disconnected, the allocation unit 40 may change allocation of ECCH to other time slots, or may allocate EDCH to other time slots.

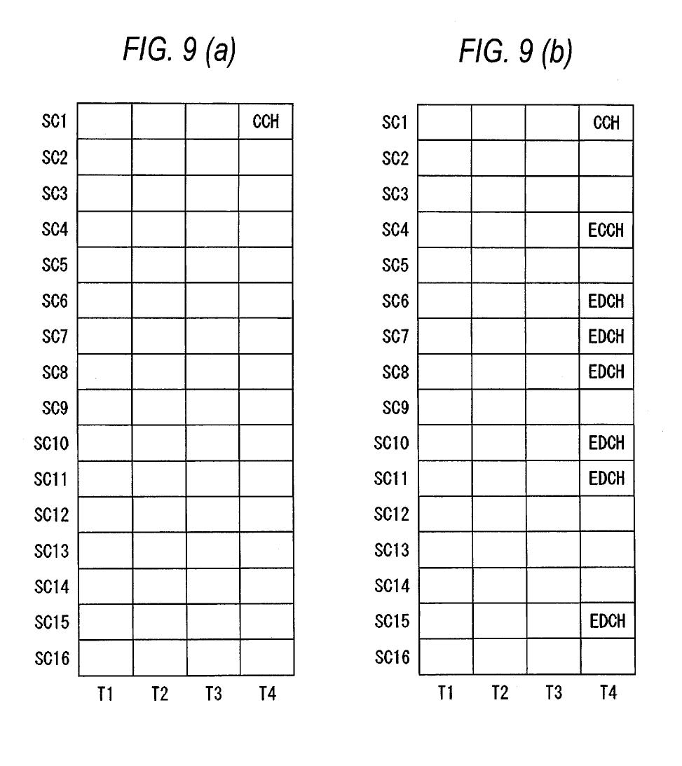

FIGS. 9(a) and 9(b) show allocation in the second base station apparatus 10b. The reference marks in FIGS. 9(a) and 9(b) are the same as those in FIG. 3. FIG. 9(a) shows allocation of a burst prior to performing handover. The second base station apparatus 10b allocates a control channel (also referred to as “CCH”) to T4 of SC1. FIG. 9(b) shows allocation when performing handover. As described above, the allocation unit 40 allocates ECCH in the time slot, “T4,” in which CCH is allocated. Here, ECCH is allocated to T4 of SC4. In addition, the allocation unit 40 allocates EDCHs to a plurality of bursts of T4. In addition, the generation unit 44 notifies the allocation of EDCH to the terminal device 12 through ECCH.

This configuration can be embodied by a computer CPU, a memory, or other LSIs in terms of hardware, and a program loaded in a memory and having a communication function, and so on in terms of software. Herein, functional blocks expressed by the interconnections thereof have been illustrated. Thus, it is to be understood by one of ordinary skill in the art that the functional blocks can be embodied in many different forms of hardware, software, or a combination thereof.

The terminal device 12 illustrated in FIG. 1 has the same configuration as that of the base station apparatus 10 illustrated in FIG. 7. In addition, differences in function between the terminal device 12 and the base station apparatus 10 exist in ranging process, channel allocation, and ECCH generation, etc. However, since these differences have been explained, explanation thereof is omitted herein. The terminal device 12 detects deterioration of communication quality when communicating with the first base station apparatus 10a. The terminal device 12 notifies the deterioration of communication quality to the first base station apparatus 10a. Thereafter, the terminal device 12 receives downlink ECCH from the first base station apparatus 10a and releases EDCHs allocated in time slots other than a time slot, in which ECCH is allocated, in accordance with an instruction included in the downlink ECCH. Then, the terminal device 12 searches a handover destination base station apparatus in time slots other than the time slot, in which ECCH is allocated.

The terminal device 12 requests handover to the second base station apparatus 10b, which is a handover destination base station apparatus. In the terminal device 12, ECCH is allocated to the same time slot as CCH from the second base station apparatus 10b. The terminal device 12 performs communication with the second base station apparatus 10b by the EDCH indicated in ECCH. Here, a time slot, in which EDCH is allocated, is same as the time slot, in which ECCH is allocated. Thereafter, the terminal device 12 disconnects the connection to the first base station apparatus 10a. Then, the terminal device 12 performs communication with the second base station apparatus 10b using EDCHs allocated in time slots other than the time slot, in which ECCH is allocated.

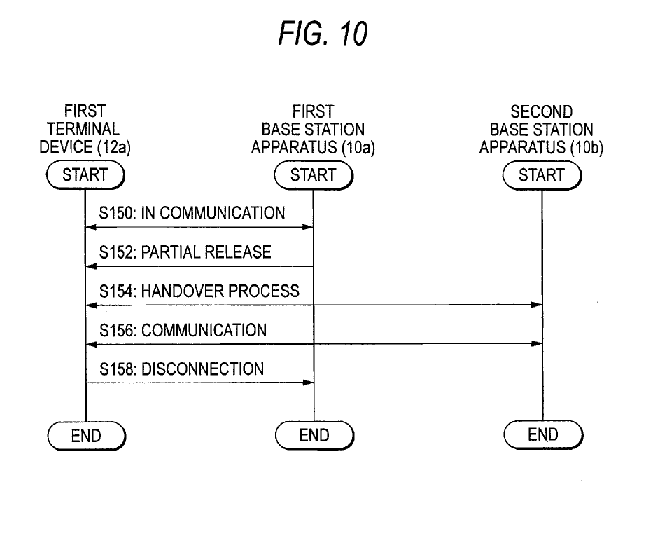

Operation of the communication system 100 according to the above configurations will be explained. FIG. 10 is a sequence view showing the sequence of handover process in the communication system 100. The first terminal device 12a and the first base station apparatus 10a are performing communication with each other (S150). The first base station apparatus 10a notifies release of a part of EDCHs to the first terminal device 12a (S152). The first terminal device 12a and the second base station apparatus 10b perform handover process (S154). The first terminal device 12a and the second base station apparatus 10b perform communication (S156). Thereafter, the first terminal device 12a requests disconnection to the first base station apparatus 10a (S158).

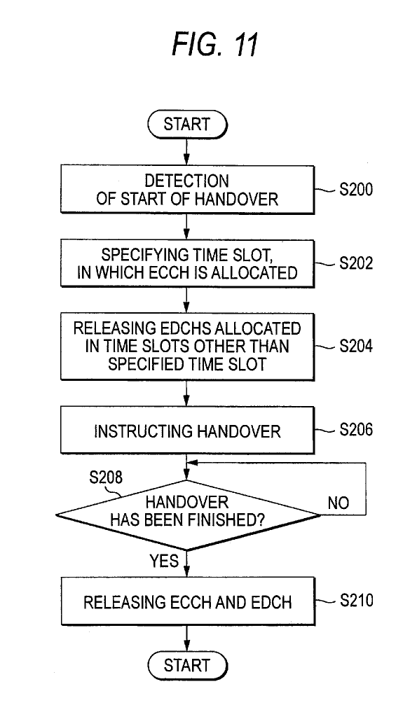

FIG. 11 is a flow chart showing the sequence of handover process in the first base station apparatus 10a. The detection unit 42 detects start of handover (S200). The allocation unit 40 specifies a time slot, in which ECCH is allocated (S202). The allocation unit 40 releases EDCHs allocated in time slots other than the specified time slot (S204). The generation unit 44 instructs the first terminal device 12a through the IF unit 26 to the RF unit 20 to perform handover (S206). If the handover process is not finished (N of S208), follow-up process is on standby. If handover process is finished (Y of S208), the allocation unit 40 releases ECCH and EDCH (S210).

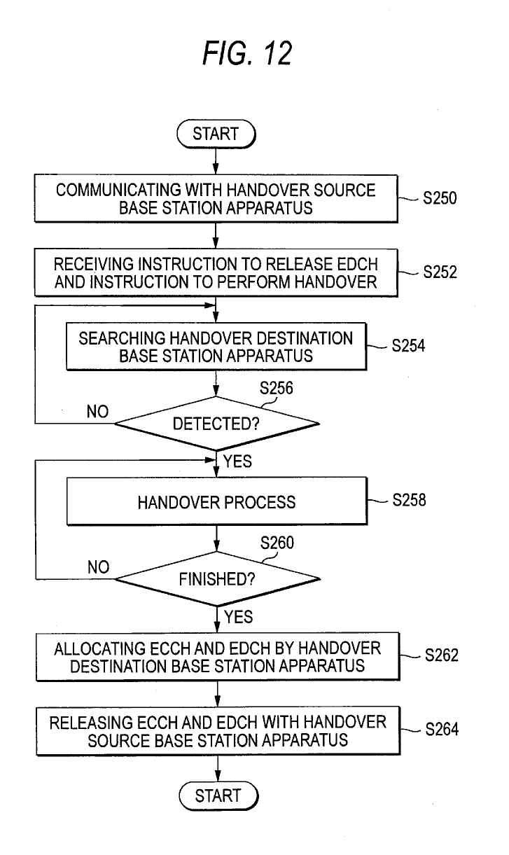

FIG. 12 is a flow chart showing the sequence of handover process in the first terminal device 12a. The first terminal device 12a performs communication with a handover source base station apparatus (S250). When receiving an instruction to release EDCH and an instruction to perform handover from the handover source base station apparatus (S252), the first terminal device 12a searches a handover destination base station apparatus (S254). If no handover destination base station apparatus is detected (N of S256), process is returned to 5254. If a handover destination base station apparatus is detected (Y of S256), the first terminal device 12a performs handover process between itself and the handover destination base station (S258). If handover process is not finished (N of S260), process is returned to S258. If handover process is finished (Y of S260), the first terminal device 12a is allocated with ECCH and EDCH from the handover destination base station apparatus (S262). The first terminal device 12a releases the ECCH and the EDCH between itself and the handover source base station apparatus (S264).

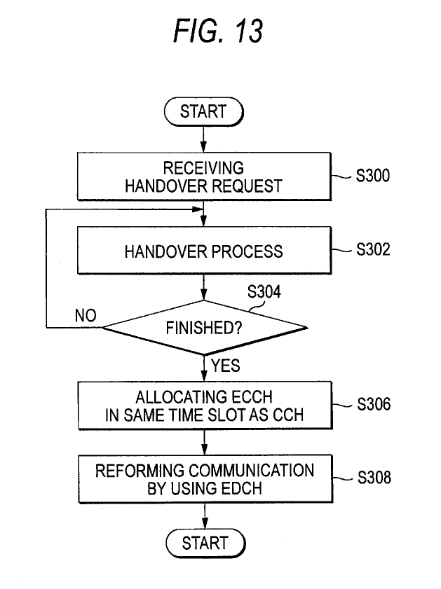

FIG. 13 is a flow chart showing the sequence of handover process in the second base station apparatus 10b. Upon receiving a handover request (S300), the allocation unit 40 performs handover process (S302). If the handover process is not finished (N of S304), process is returned to S302. If the handover process is finished (Y of S304), the allocation unit 40 allocates ECCH in the same time slot as CCH (S306). The RF unit 20 to the IF unit 26 perform communication with the first terminal device 12a through EDCH (S308).

Hereinafter, a modified embodiment will be explained. Similarly to the handover source base station apparatus according to an embodiment of the present invention, the handover source base station apparatus according to a modified embodiment releases EDCH allocated to the terminal device 12 when performing handover process. The handover source base station apparatus according to an embodiment of the present invention releases all EDCHs in times slots other than the time slot, in which ECCH is allocated. Meanwhile, the handover source base station apparatus according to a modified embodiment acquires a timing, in which CCH of a neighboring base station apparatus is allocated, in advance. As described above, since a control channel is allocated for a super frame, timing is specified by a combination of a frame and a time slot. The handover source base station apparatus releases EDCH allocated at the acquired timing. As a result, a modified embodiment can reduce the number of EDCHs to be released, compared to the above embodiment of the present invention.

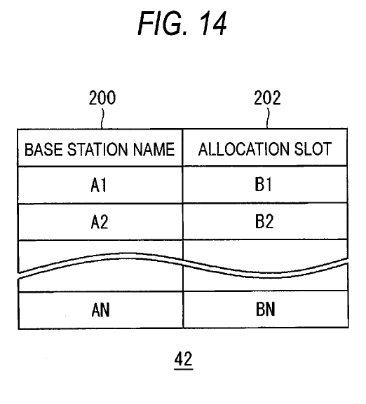

The type of the communication system 100 according to a modified embodiment is the same as that of the communication system 100 illustrated in FIG. 1. In addition, the type of the base station apparatus 10 according to a modified embodiment is the same as that of the base station apparatus 10 illustrated in FIG. 7. The detection unit 42 acquires information about a time slot, in which CCH from another neighboring base station apparatus 10 is allocated, through the RF unit 20 to the IF unit 26. This CCS is a signal used for the terminal device 12 to identify the existence of another base station apparatus 10. In addition, since known technique for acquisition of information can be used, explanation thereof is omitted herein. For example, the detection unit 42 acquires information at timing, in which the base station apparatus 10 establishes frame synchronization, once a day, and generates a table. FIG. 14 shows data structure of a table stored in the detection unit 42 according to a modified embodiment of the present invention. As illustrated, a base station column 200 and an allocation slot column 202 are included. In the base station column 200, numbers to identify the neighboring communication systems 100 are indicated, and in the allocation slot column 202 a timing, in which CCH is allocated is indicated. Attention is returned to FIG. 7.

The allocation unit 40 specifies a time slot corresponding to CCH of another communication system 100 among time slots other than the time slot, in which ECCH is allocated, with reference to the table stored in the detection unit 42. The allocation unit 40 releases EDCHs included in the specified time slots. Since follow-up process is the same as those in an embodiment of the present invention, explanation thereof is omitted herein.

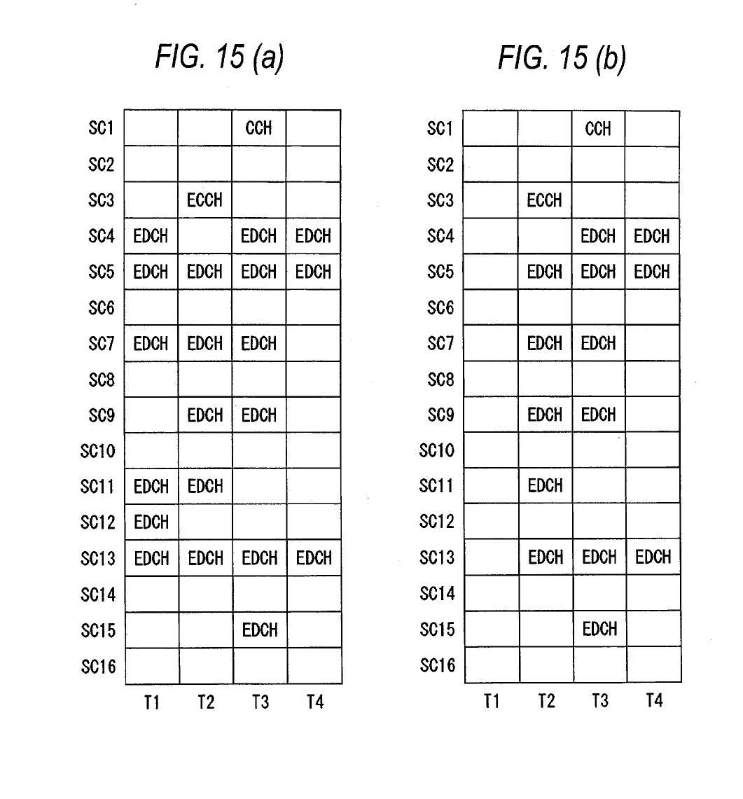

FIGS. 15(a) and 15(b) show allocation in a first base station apparatus 10a according to a modified embodiment of the present invention. The reference marks in FIGS. 15(a) and 15(b) are the same as those in FIG. 3. FIG. 15(a) shows allocation of bursts prior to performing handover, which is the same as that in FIG. 8(a), and thus explanation thereof is omitted herein. FIG. 15(b) shows allocation when performing handover. As described above, the allocation unit 40 specifies the time slot, “T1,” corresponding to CCH of another communication system 100 among time slots other than the time slot, in which ECCH is allocated. The allocation unit 40 secures EDCHs allocated in the time slots, “T2,” “T3,” and “T4.” Accordingly, the allocation of EDCHs in T2, T3, and T4 in FIG. 15(b) is the same as the allocation of EDCHs in FIG. 15(a). Meanwhile, the allocation unit 40 releases all EDCHs in the specified time slot, “T1.” Then, the generation unit 44 notifies the allocation of EDCHs to the terminal device 12 through ECCH.

According to an embodiment of the present invention, since EDCH in the time slot, in which ECCH is allocated, is secured, while EDCH in other time slots is released, time slots, which are not used for communication, can increase. Since time slots, which are not used for communication, increase, time slots to search a handover destination base station apparatus can increase. Further, since time slots to search a handover destination base station apparatus increase, time for search can be reduced. Since time for search is reduced, time required for handover process can be reduced even in the case where EDCH is allocated to a random burst. Since EDCHs included in time slots other than the time slot, in which ECCH is allocated, are released, time slots, which are not used for communication, can increase. In addition, since only EDCHs allocated in a time slot, in which another base station apparatus allocates a control channel, are released, the number of EDCHs to be maintained can increase. Further, since the number of EDCHs to be maintained increases, reduction of communication speed can be suppressed.

The present invention has been described with reference to embodiments. It is apparent to one of ordinary skill in the art that the embodiments are exemplary, and various modified embodiments to a combination of elements or process are possible, and such modified embodiments fall under the scope of the present invention. For example, in the embodiments above, at least EDCH of time slots, in which ECCH is allocated, is secured. However, if at least ECCH is secured, EDCHs included in the time slots, in which ECCH is allocated, may be released.

The present application is based on the Japanese Patent Application No. 2008-084955 filed on Mar. 27, 2008, the disclosures of which are hereby incorporated by reference.

1. A base station apparatus comprising:
an allocation unit which allocates, in a frame, different channels for data between the base station and a terminal device, and control information about the data, the frame formed with a plurality of time slots by being time-multiplexed, each time slot formed with a plurality of channels by being frequency-multiplexed; and
a communication unit which performs communication with the terminal device by using the control information and the data, for which channels are allocated by the allocation unit,
wherein the allocation unit, while securing at least the control information, releases at least one data which is not secured, and instructs the terminal device to perform handover process by using a time slot, in which no data is allocated.

2. The base station apparatus according to claim 1,
wherein the allocation unit secures at least data included in a time slot, in which the control information is allocated.

3. The base station apparatus according to claim 1,
wherein the allocation unit releases data included in a time slot other than the time slot, in which the control information is allocated.

4. The base station apparatus claimed in claim 1, further comprising:
an acquisition unit which acquires information about a channel, in which a notification signal from another base station apparatus is allocated, the notification signal used for a terminal device to recognize existence of another base station apparatus,
wherein the allocation unit includes:
an unit which specifies a time slot corresponding to the channel included in the information acquired by the acquisition unit, among time slots other than the time slot, in which the control information is allocated; and
an unit which releases data included in the specified time slot.

5. The base station apparatus claimed in claim 1, wherein the allocation unit releases data included in at least one time slot other than the time slot, in which the control information is allocated.

6. The base station claimed in claim 1,
wherein the allocation unit instructs the terminal device to perform the handover process by transmitting an instruction signal to instruct handover process and control information indicating data to be released, to the terminal device.

7. An allocation method for allocating, in a time frame, different channels for data between a base station apparatus and a terminal device and control information about the data, the time frame formed with a plurality of time slots being time-multiplexed, each time slot formed with a plurality of channels being frequency-multiplexed, the method comprising:
while securing at least the control information, releasing at least one data which is not secured, and instructing the terminal device to perform handover process by using a time slot, in which no data is allocated.

8. The allocation method claimed in claim 7,
wherein the securing secures at least data included in a time slot, in which the control information is allocated.

9. The allocation method claimed in claim 7, wherein the instructing is performed by transmitting an instruction signal to instruct the handover process and control information indicating data to be released, to the terminal device.
